(19) United States
(12) Patent Application Publication
(10) Pub. No.: US 2009/0083745 A1
(43) Pub. Date: Mar. 26, 2009

(54) Techniques for Maintaining Task Sequencing in a Distributed Computer System

(76) Inventors: Jinmei Shen, Rochester, MN (US); Hao Wang, Rochester, MN (US)

Correspondence Address: IBM CORPORATION, 3605 HIGHWAY 52 NORTH, DEPT 917, ROCHESTER, MN, 55901-7829, US

(21) Appl. No.: 11/860,640

(22) Filed: Sep. 25, 2007

(51) Int. Cl. G06F 9/46

(52) U.S. Cl. 718/103

(57) ABSTRACT

A technique for operating a distributed computer system includes receiving one or more current processing task elements. Each of the one or more respective current processing elements is associated with a different task that is currently being processed in a server cluster. A first task element is selected from the one or more respective current processing task elements and respective servers in the server cluster are requested to update pending task elements, including the one or more respective current processing task elements, based on the first task element.

### BACKGROUND

1. Field

This disclosure relates generally to distributed computer systems and, more specifically, to techniques for maintaining task sequencing in a distributed computer system.

2. Related Art

Distributed computing is a computer processing technique in which different parts of a program run simultaneously on two or more computers that are communicating with each other over a network. Division of a program in distributed computing typically accounts for different environments in which different sections of a program execute. For example, different computer systems may have different file systems and different hardware components and, as such, provide different performance levels. Distributed computing is generally considered a natural result of the use of networks to allow computers to efficiently communicate and effectively coordinate timely task completion.

However, distributed computing is distinct from computer networking, which is a term that is usually used to refer to two or more computers that interact with each other but do not typically share the processing of a single program. For example, the world wide web is an example of a computer network, but is not, by itself, an example of distributed computing. There are numerous technologies, such as remote procedure calls (RPC), remote method invocation (RMI), and .NET remoting, that are used to construct distributed computations. The various types of distributed computer systems attempt to connect users and resources in a transparent, open, and scalable manner.

Today, a distributed computer system may employ various techniques to facilitate cooperation and sequencing between individual computer systems of the distributed computer system. For example, a distributed computer system may employ a monotonic (increasing or decreasing) function whose numbers facilitate cooperation and sequencing between servers in the distributed computer system that are performing one or more related tasks. Unfortunately, using numbers of a monotonic function to facilitate cooperation and sequencing between servers in a distributed computer system may lead to undesired results. For example, when a monotonously increasing number (MIN) sequence (utilized by a conventional distributed computer system to enforce task execution order) has reached a maximum value, computer systems of the conventional distributed computer system have been shut-down for maintenance (deletion of log files, etc.) and resetting of the MIN sequence. In this case, during shut-down, the computer systems of the distributed computer system have been unavailable for normal functions and, as such, an associated service provided by the computer systems (e.g., servers) of the distributed computer system has been unavailable to customers of the service. Depending upon the utilization of the distributed computer system and a maximum value of the MIN sequence, frequent (daily, weekly, or monthly) maintenance may be required. While a day and time may be selected to minimize the adverse effect of the maintenance on a distributed computer system, service interruption at any time or day may be unacceptable to many customers of an associated service. Moreover, in addition to lack of availability of the system to customers during resetting of a MIN sequence, maintenance costs related to resetting the MIN sequence may approach eighty percent of a total maintenance cost of the system.

### SUMMARY

According to one aspect of the present disclosure, a technique for operating a distributed computer system includes receiving one or more respective current processing task elements. Each of the one or more respective current processing elements is associated with a different task that is currently being processed in a server cluster. A first task element is selected from the one or more respective current processing task elements and respective servers in the server cluster are requested to update pending task elements, including the one or more respective current processing task elements, based on the first task element.

According to another aspect of the present disclosure, a technique for operating a distributed computer system includes receiving, at respective servers in a server cluster, a first task element. One or more respective current processing task elements are then updated based on the first task element. Each of the one or more respective current processing elements is associated with a different task that is currently being processed by one of the respective servers and the first task element corresponds to one of the one or more respective current processing task elements.

According to one embodiment of the present disclosure, a distributed computer system comprises a server cluster (including multiple servers) and a task server that is in communication with the server cluster. The task server is configured to receive one or more respective current processing task elements. Each of the one or more respective current processing elements is associated with a different task that is currently being processed in the server cluster. The task server is also configured to select a first task element from the one or more respective current processing task elements and request that the multiple servers update pending task elements, including the one or more respective current processing task elements, based on the first task element.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a block diagram of an example distributed computer system.

FIGS. 2-3 include a flowchart of an example process for resetting a monotonic function sequence according to the present disclosure.

FIG. 4 is a flowchart of an example process for updating pending task elements in a server of a server cluster according to the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to an electronic, magnetic, optical, electromagnetic, infrared, or semiconductor system, apparatus, or device. More specific examples (a non-exhaustive list) of the computer-readable medium storage would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages. Portions of the program code may execute entirely on a single computer, on multiple computers that may be remote from each other, or as a stand-alone software package. When multiple computers are employed, one computer may be connected to another computer through a local area network (LAN) or a wide area network (WAN), or the connection may be, for example, through the Internet using an Internet service provider (ISP).

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus implement the functions/acts specified in the flowchart and/or block diagram block or blocks. As used herein, the term “coupled” includes both a direct electrical connection between blocks or components and an indirect electrical connection between blocks or components achieved using intervening blocks or components.

Techniques according to the present disclosure facilitate resetting elements (e.g., numbers) in a monotonic sequence, e.g., a monotonously increasing number (MIN) sequence, without interrupting services provided by computers systems of a distributed computer system. Moreover, the techniques disclosed herein maintain data integrity and task order when the elements provided by a monotonic sequence are reset. While the discussion herein is focused on the use of elements of a MIN sequence to facilitate cooperation and sequencing in a distributed computer system, it is contemplated that the disclosed techniques are equally applicable to the use of elements of a monotonously decreasing number (MDN) sequence. Moreover, it is contemplated that the disclosed techniques are applicable to utilization of elements (e.g., characters, numbers, or symbols) of any sequence whose elements may be utilized to uniquely identify tasks (i.e., jobs or processes) employed on different processing nodes, e.g., servers. The techniques disclosed herein readily facilitate the resetting of elements of a sequence that have been distributed to a wide variety of processing nodes (that perform assigned tasks) to facilitate cooperation and sequencing between the processing nodes, without requiring the reassignment of uncompleted tasks following resetting of the elements of the sequence.

The techniques disclosed herein may be incorporated within a wide variety of products, e.g., software products that are designed to set-up, operate, and integrate e-business applications across multiple computing platforms using web technologies (such as WebSphere™ products), as well as various application programmer interface (API) products (such as ObjectGrid™ products). For example, in ObjectGrid™ products monotonic functions may be employed to coordinate a dynamic core group member change sequence to all servers (machines), coordinate placement and balancing of shard sequences between servers, and to recover replica data. As another example, WebSphere™ products may use a monotonic function for dynamic core group generating, dynamic group member synchronization, and dynamic server control. In sum, the techniques disclosed herein may be utilized in virtually any application that employs a monotonic function to provide elements that are used to coordinate sequential actions among multiple machines.

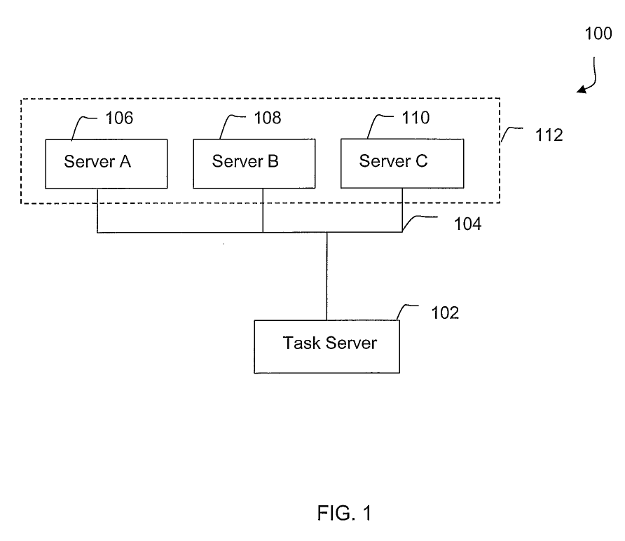

With reference to FIG. 1, an example distributed computer system 100 is illustrated that includes three servers 106, 108, and 110 that are included within a server cluster 112. The servers 106-110 are coupled to a task server 102, via a network (e.g., an intranet or the Internet) 104. While the cluster 112 is shown as including three servers, it should be appreciated that a cluster configured according to various aspects of the present disclosure may include two or more servers that are each assigned one or more tasks that may be associated with the same or a different sequence. The servers 106-110 may co-located or remotely located. The task server 102 assigns tasks and associated task elements (which are provided by a monotonic function) to the tasks assigned to the servers 106-110.

It should be appreciated that a different number of tasks may be assigned to each of the servers 106-110 and that the servers 106-110 may have different functionality and different processing capabilities. The tasks may correspond to a wide variety of different related transactions in various fields (e.g., financial (such as buying and selling stocks, withdrawing funds from or adding funds to a financial account, etc.) and academic fields). In general, the task server 102 is configured to assign tasks to the servers 106-110, according to the capabilities of the servers 106-110, and to cause the task elements to be reset when the elements approach a predetermined value (e.g., a maximum value achievable by a MIN sequence or a minimum value achievable by a MDN sequence) in order to reduce the likelihood of a break of the cluster 112.

The task server 102 (which essentially functions as a command server) may, for example, be elected from a server group that includes the servers 102 and 106-110. A task queue (maintained by an elected task server) may be replicated to one or more other servers in the case of a failure of the elected task server. In this case, when the elected task server fails, one of the servers that is maintaining the replicated task queue may be elected as the new task server. In general, this approach ensures that a distributed computer system may remain operational when a current task server fails. A partitioned task server technique may also be employed to enhance scalability of a distributed computer system. According to the partitioned task server technique, a main task server may be configured to distribute jobs to different secondary task servers according to a job partition key.

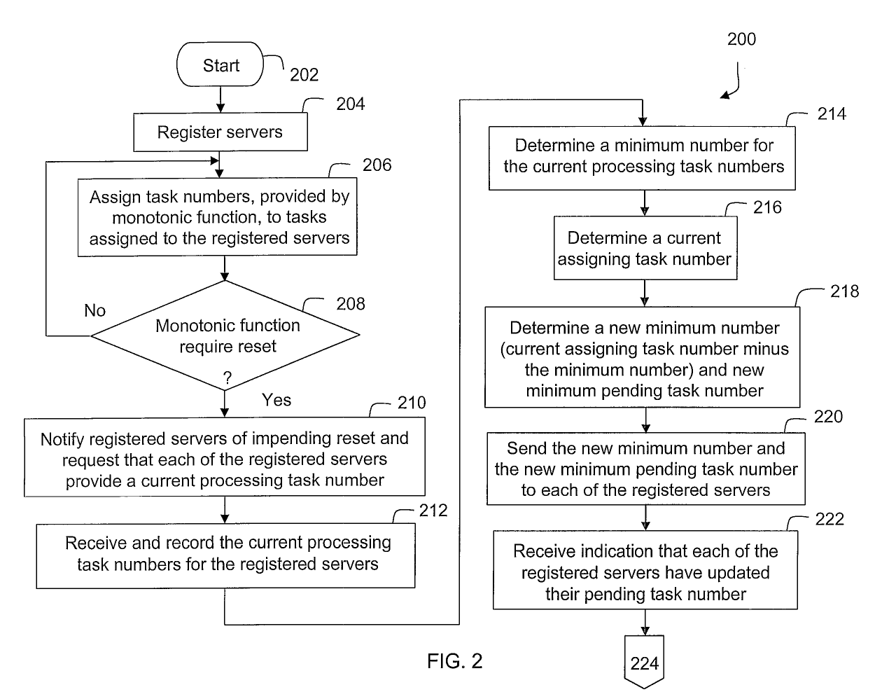

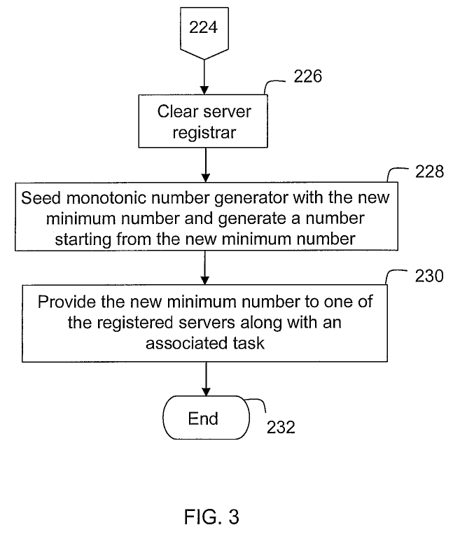

With reference to FIGS. 2 and 3, a process 200 for resetting elements of a MIN sequence is illustrated. To facilitate understanding, the process 200 is discussed in conjunction with the distributed computer system 100 of FIG. 1. The process 200 is initiated in block 202, at which point control transfers to block 204 where the task server 102 registers the servers 106-110, which are to be assigned tasks associated with one or more applications (programs), in a server registrar. In block 206, the server 102 assigns respective task numbers (provided by a monotonic function) to respective tasks assigned to the servers 106-110. Next, in decision block 208, the server 102 determines whether the monotonic function requires reset. A MIN sequence may correspond to any number of binary bits (e.g., two bits, four bits, eight bits, sixteen bits, thirty-two bits). As one specific example, a MIN sequence may be limited to four binary bits. In this case, sixteen numbers (i.e., 0-15) are available as task numbers before a monotonic function that increases by one requires reset.

Assuming that the MIN sequence is limited to sixteen decimal numbers and fifteen tasks are to be equally divided among the servers 106-110, the server (server A) 106 may be assigned tasks with the task numbers 0, 3, 6, 9, and 12; the server (server B) 108 may be assigned tasks with the task numbers 1, 4, 7, 10, and 13; and the server (server C) 110 may be assigned tasks with the task numbers 2, 5, 8, 11, and 14 (over multiple iterations of the loop including blocks 206 and 208). In this example, the tasks are performed in an order that is dictated by the task numbers. For example, the server 106 performs the task associated with the task number ‘0’ before the server 106 performs the task associated with the task number ‘3’. Similarly, the server 106 performs the task associated with the task number ‘3’ before the server 106 performs the task associated with the task number ‘6’. Likewise, the server 106 performs the task associated with the task number ‘6’ before the server 106 performs the task associated with the task number ‘9’. Finally, the server 106 performs the task associated with the task number ‘9’ before the server 106 performs the task associated with the task number ‘12’. When the monotonic function does not require reset in block 208 (e.g., a current assigning task number is less than 15), control transfers to block 206. When the monotonic function requires reset in block 208 (e.g., the current assigning task number is equal to 15), control transfers to block 210.

In block 210, the server 102 notifies the servers 106-110 of impending reset of the MIN sequence generator and requests that each of the servers 106-110 provide a current processing task number (i.e., a task number whose associated task is currently being processed). Next, in block 212, the server 102 receives and records (logs) the current processing task numbers for the servers 106-110. For example, the server 106 may return a current processing task number of twelve (which means that the tasks associated with task numbers 0, 3, 6, and 9 have been completed), the server 108 may return a current processing task number of seven (which means that the tasks associated with task numbers 1 and 4 have been completed and the tasks associated with task numbers 10 and 13 have not been started), and the server 110 may return a current processing task number of fourteen (which means that the tasks associated with tasks 2, 5, 8 and 11 are complete). Then, in block 214, the server 102 determines a minimum number (in this case, seven) for the current processing task numbers (in this case, twelve, seven, and fourteen). Next, in block 216, the server determines a current assigning task number (in this case, fifteen), which is the next task number to be assigned to a new task. Then, in block 218, the server 102 determines a new minimum number (i.e., current assigning task number minus the minimum number, which in this case is eight) and a new minimum pending task number (i.e., the minimum current processing task number, which in this case is seven).

Next, in block 220, the server 102 sends the new minimum number and the new minimum pending task number to each of the servers 106-110. Upon receiving the new minimum number and the new minimum pending task number, each of the servers 106-110 is configured to update their pending task numbers. For example, the server 106 is configured to change the pending task number twelve to five (i.e., 12−7=5), the server 108 is configured to change the pending task numbers seven, ten, and thirteen to zero (7−7=0), three (10−7=3), and six (13−7=6), respectively, and the server 110 is configured to change the pending task number fourteen to seven (i.e., 14−7=7). Next, in block 222, the server 102 receives an indication that each of the servers 106-110 has updated their respective pending task number (or numbers). It should be appreciated that, at any given point in time, each of the servers 106-110, may have zero, one, or more than one pending tasks that have associated pending task numbers. Then, in block 226, the server 102 clears the server registrar. Next, in block 228, the server 102 seeds the monotonic number generator with the new minimum number (in this case eight (15−7=8) and generates a number starting with the new minimum number. It should be appreciated that a monotonic number generator may be configured to increment by one or any other desired value. Then, in block 230, the server 102 provides the new minimum number to the servers 106-110. Following block 230, the process 200 terminates in block 232.

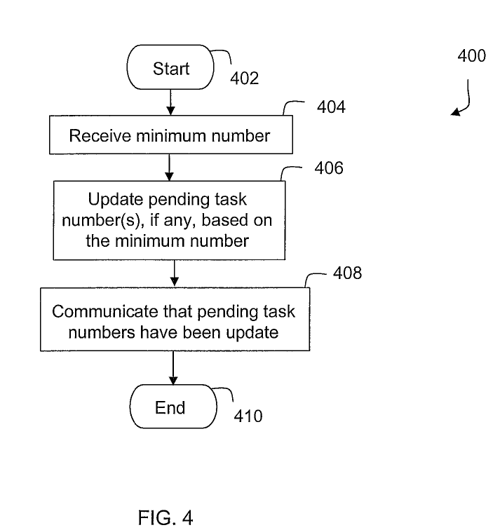

With reference to FIG. 4, a process 400 for updating pending task elements in a server of a server cluster is illustrated. The process 400 is initiated in block 402, at which point control transfers to block 404. In block 404, the servers 106-110 receive a minimum number that corresponds to a minimum current processing task number for all of the servers 106-110. Next, in block 406, the servers 106-110 update respective pending task numbers, e.g., by subtracting the minimum number from the respective pending task numbers. As noted in the above example, the server 108 is configured to change the pending task numbers seven, ten, and thirteen to zero (7−7=0), three (10−7=3), and six (13−7=6), respectively. Then, in block 408, the servers 106-110 communicate with the server 102 that their respective pending task numbers have been updated. The server 102 may then clear the server registrar, as noted above, and assign a new task with the new minimum number (in this case eight) to one of the servers 106-110. From block 408, control transfers to block 410 where the process 400 terminates.

Accordingly, techniques have been disclosed herein that facilitate resetting elements (e.g., task numbers) provided by a monotonic sequence that are used to order task execution without interrupting a service or services provided by computer systems of a distributed computer system. Moreover, the techniques disclosed herein maintain data integrity and a service order when the elements (e.g., task numbers) of the monotonic sequence are reset.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of operating a distributed computer system, comprising:
receiving one or more respective current processing task elements, wherein each of the one or more respective current processing task elements is associated with a different task that is currently being processed in a server cluster;
selecting a first task element from the one or more respective current processing task elements; and
requesting that respective servers in the server cluster update pending task elements, including the one or more respective current processing task elements, based on the first task element.

2. The method of claim 1, further comprising:
requesting one of the one or more respective current processing task elements from each of the respective servers.

3. The method of claim 1, wherein the receiving one or more respective current processing task elements further comprises:
receiving, at a task server, the one or more respective current processing task elements in response to a request for the one or more respective current processing task elements.

4. The method of claim 1, wherein the one or more respective current processing task elements each correspond to a different number in a monotonously increasing number sequence.

5. The method of claim 1, wherein the one or more respective current processing task elements each correspond to a different number in a monotonously decreasing number sequence.

6. The method of claim 1, wherein the one or more respective current processing task elements each correspond to a different character in a character sequence.

7. The method of claim 1, wherein the one or more respective current processing task elements each correspond to a different symbol in a symbol sequence.

8. The method of claim 1, wherein the first task element corresponds to a minimum one of the one or more respective current processing task elements.

9. The method of claim 1, wherein the first task element corresponds to a maximum one of the one or more respective current processing task elements.

10. A method of operating a distributed computer system, comprising:
receiving, at respective servers in a server cluster, a first task element; and
updating one or more respective current processing task elements based on the first task element, wherein each of the one or more respective current processing task elements is associated with a different task that is currently being processed by one of the respective servers and the first task element corresponds to one of the one or more respective current processing task elements.

11. The method of claim 10, wherein the one or more respective current processing task elements each correspond to a different number in a monotonously increasing number sequence.

12. The method of claim 10, wherein the one or more respective current processing task elements each correspond to a different number in a monotonously decreasing number sequence.

13. The method of claim 10, wherein the one or more respective current processing task elements each correspond to a different character in a character sequence or a different symbol in a symbol sequence.

14. The method of claim 10, wherein the first task element correspond to a minimum or a maximum one of the one or more respective current processing task elements.

15. A distributed computer system, comprising:
a server cluster including multiple servers; and
a task server in communication with the server cluster, wherein the task server is configured to:
receive one or more respective current processing task elements, wherein each of the one or more respective current processing task elements is associated with a different task that is currently being processed in the server cluster;
select a first task element from the one or more respective current processing task elements; and
request that the multiple servers in the server cluster update pending task elements, including the one or more respective current processing task elements, based on the first task element.

16. The distributed computer system of claim 15, wherein the one or more respective current processing task elements each correspond to a different number in a monotonously increasing number sequence or a monotonously decreasing number sequence.

17. The distributed computer system of claim 15, wherein the one or more respective current processing task elements each correspond to a different character in a character sequence or a different symbol in a symbol sequence.

18. The distributed computer system of claim 15, wherein the first task element corresponds to a minimum or maximum one of the one or more respective current processing task elements.

19. The distributed computer system of claim 15, wherein each of the multiple servers is configured to:
receive the first task element; and
update an associated one of the one or more respective current processing task elements based on the first task element.

20. The distributed computer system of claim 19, wherein each of the multiple servers is further configured to:
update associated ones of the pending task elements based on the first task element.
